(19) United States
(12) Patent Application Publication
(10) Pub. No.: US 2016/0368393 A1
(43) Pub. Date: Dec. 22, 2016

(54) BATTERY-POWERED WORK VEHICLE AND WORK VEHICLE BATTERY

(71) Applicant: KOMATSU LTD., Tokyo (JP)

(72) Inventors: Manabu Yamashiro, Oyama-shi (JP); Kazuo Yamane, Oyama-shi (JP)

(73) Assignee: KOMATSU LTD., Tokyo (JP)

(21) Appl. No.: 14/891,364

(22) PCT Filed: Jun. 22, 2015
(86) PCT No.: PCT/JP2015/067931

§ 371 Date: Nov. 16, 2015

(51) Int. Cl. B60L 11/18; B66F 9/075; H01M 2/02; H01M 10/613; H01M 10/04; H01M 2/10; H01M 10/6563; H01M 10/625; B60K 1/04; H01M 2/20

(52) U.S. Cl. CPC B60L 11/1877; B60L 11/1879; B60K 1/04; B66F 9/07554; B66F 9/07531; H01M 2/024; H01M 2/206; H01M 10/04; H01M 2/1083; H01M 2/1077; H01M 10/6563; H01M 10/625; H01M 10/613; B60K 2001/0416; H01M 2220/20

(57) ABSTRACT

A battery-powered work vehicle includes: a vehicle body on which a battery is mounted; a counter weight disposed at one end portion of the vehicle body and including a storage unit opened to an upper side of the vehicle body and configured to store a part of the battery; a passage disposed at a part of the counter weight and configured to connect the storage unit to an outside of the counter weight; and a cover provided above the counter weight and configured to cover a part of an opening of the passage on the outside of the counter weight.

### FIELD

The present invention relates to a battery-powered work vehicle and a work vehicle battery.

### BACKGROUND

For example, there is a work vehicle mounted with a motor used for traveling, and made to travel by supplying power to the motor from a battery. Since the battery used in this kind of work vehicle generates heat during charge, the battery is needed to be cooled. For example, Patent Literature 1 discloses a technology of cooling a battery mounted on a battery-powered forklift.

### CITATION LIST

### Patent Literature

Patent Literature 1: JP Patent No. 5619304

### SUMMARY

### Technical Problem

In the case of increasing a size of a battery-powered work vehicle or extending operation time of the battery-powered work vehicle, capacity of a mounted battery is increased as well. When the battery capacity is increased, an amount of heat generated by the battery during charge and discharge is also increased. Therefore, cooling capacity for the battery is needed to be improved. In the case where the battery capacity is increased, the size of the battery is increased. Consequently, a battery space can be hardly secured when the battery is mounted on the battery-powered work vehicle. As a result, there may be a case where the battery may be mounted at a portion where heat is hardly radiated.

The present invention is directed to providing a battery-powered work vehicle in which a work vehicle battery mounted at a portion where heat is hardly radiated is cooled.

### Solution to Problem

According to the present invention, a battery-powered work vehicle, comprises: a vehicle body on which a battery is mounted; a counter weight disposed at one end portion of the vehicle body, and including a storage unit opened to an upper side of the vehicle body, the storage unit storing a part of the battery; a passage disposed at a part of the counter weight and configured to connect the storage unit to an outside of the counter weight; and a cover provided above the counter weight and configured to cover a part of an opening of the passage on outside of the counter weight.

In the present invention, it is preferable that the battery is mounted inside the vehicle body, and the vehicle body includes, on one side portion in a width direction, a first hole connecting inside and outside of the vehicle body, and includes, on the other side portion in the width direction, a second hole connecting the inside and the outside of the vehicle body.

According to the present invention, a battery-powered work vehicle, comprises: a vehicle body on which a battery including a plurality of battery cells and a battery case to store the battery cells is mounted; a counter weight disposed on one end portion of the vehicle body, and including a storage unit opened to an upper side of the vehicle body, the storing unit storing a part of the battery; a passage disposed at a part of the counter weight and configured to connect the storage unit to an outside of the counter weight; and a cover disposed above the counter weight and configured to cover at least a part of a portion opened to an upper side of the counter weight, wherein the battery case includes a hole at a part of a portion stored in the counter weight.

In the present invention, it is preferable that a position of the passage in a width direction of the battery-powered work vehicle is aligned with a position of the hole.

In the present invention, it is preferable that the passage and the hole at least partly overlap in the width direction of the battery-powered work vehicle.

In the present invention, it is preferable that the cover has a shape that is narrowed toward a rear side of the battery-powered work vehicle when viewed from above, the battery case has a shape in which a portion located on the rear side of the battery-powered work vehicle is narrowed when viewed from above, and the passage is disposed at a portion of the counter weight corresponding to the narrowed portion of the cover, and the hole is disposed at the narrowed portion of the battery case.

In the present invention, it is preferable that the battery case includes a member to cover the hole, and the member includes an opening configured to allow gas to flow into the hole.

In the present invention, it is preferable that a lower end of the hole is positioned higher than an upper end of the passage.

In the present invention, it is preferable that the battery is mounted inside the vehicle body, the vehicle body includes, on one side portion in a width direction, a first hole connecting inside and outside of the vehicle body, and includes, on the other side portion in the width direction, a second hole connecting the inside and the outside of the vehicle body, and the hole is disposed on one side portion.

According to the present invention, a work vehicle battery mounted on a battery-driven work vehicle and configured to supply power to the work vehicle, comprises: a plurality of battery cells; a battery case including a bottom portion, a top portion facing the bottom portion, side portions connecting the bottom portion and the top portion, and configured to store the battery cells in a first space surrounded by the top portion, the bottom portion, and the side portions; a first intake port opened at a portion, out of the side portions, disposed in a width direction of the work vehicle when the battery is mounted on the work vehicle, and configured to introduce gas into the battery case; a second space formed between the side portions and ones out of the battery cells; a second intake port opened at a portion, out of the side portions, located more on a rear side of the work vehicle than the first intake port when the battery is mounted on the work vehicle, and configured to connect the second space to outside of the battery case and introduce gas into the second space; an exhaust port opened at a side portion facing the side portion where the first intake port is opened, and configured to exhaust gas from the battery case; and a fan configured to exhaust gas from the exhaust port after introducing the gas into the battery case from the first intake port and the second intake port and allowing the gas to flow contacting upper surfaces and lower surfaces of the battery cells.

In the present invention, it is preferable that the battery case includes a member to cover the second intake port, and the member includes an opening allowing gas to flow into the second intake port.

In the present invention, it is preferable that the battery case includes a sectioning member configured to section the first space between the top portion and the bottom portion, the battery cells are disposed between the top portion and the sectioning member and between the sectioning member and the bottom portion respectively, and gas introduced into the battery case from the first intake port and the second intake port flows, contacting upper surfaces and lower surfaces of the battery cells disposed between the top portion and the sectioning member, and contacting upper surfaces and lower surfaces of the battery cells disposed between the sectioning member and the bottom portion.

In the present invention, it is preferable that the second space connects the first spaces sectioned by the sectioning member, and a cable that mutually and electrically connects the battery cells is passed between one of the sectioned first spaces and the other one of the sectioned first spaces.

In the present invention, it is preferable that the battery case includes a third space formed between the side portions and the ones out of the battery cells, and located at a portion different from the second space, and a part of the exhaust port is opened to the third space.

In the present invention, it is preferable that the third space mutually connects the first spaces sectioned by the sectioning member, and a cable that mutually and electrically connects the battery cells is passed between one of the sectioned first spaces and the other one of the sectioned first spaces.

In the present invention, it is preferable that the second space is disposed on a side of the side portions where the first intake port is opened, and the third space is disposed on a side of the side portions where the exhaust port is opened.

In the present invention, it is preferable that among the side portions, a first side portion located on a rear side of the work vehicle has a size in the width direction smaller than a distance between a second side portion where the first intake port is opened and a third side portion where the exhaust port is opened when the battery is mounted on the work vehicle, and the second intake port is opened at a portion connecting the first side portion to the second side portion.

According to the present invention, the work vehicle battery mounted at the portion where heat is hardly radiated can be cooled in the battery-powered work vehicle.

### BRIEF DESCRIPTION OF DRAWINGS

FIG. 1 is a side view illustrating a battery-powered forklift according to the present embodiment in a state viewed from a left side.

FIG. 2 is a side view illustrating a part of the battery-powered forklift according to the present embodiment in a state viewed from a right side.

FIG. 3 is a perspective view illustrating the battery-powered forklift according to the present embodiment in a state viewed from obliquely above on a left rear side.

FIG. 4 is a view illustrating a counter weight in a state viewed from a rear side of the battery-powered forklift.

FIG. 5 is a view illustrating the counter weight in the state viewed from the rear side of the battery-powered forklift.

FIG. 6 is a view illustrating the counter weight in the state viewed from the rear side of the battery-powered forklift.

FIG. 7 is a side view illustrating a relation between the counter weight and a battery.

FIG. 8 is an explanatory diagram for the battery included in the battery-powered forklift according to the present embodiment.

FIG. 9 is a perspective view illustrating the battery and a battery case according to the present embodiment.

FIG. 10 is a plan view illustrating the battery and the battery case according to the present embodiment.

FIG. 11 is a right side view illustrating the battery and the battery case according to the present embodiment.

FIG. 12 is a left side view illustrating the battery and the battery case according to the present embodiment.

FIG. 13 is a diagram taken along an arrow A-A in FIG.

FIG. 14 is a diagram taken along the arrow A-A in FIG.

FIG. 15 is a diagram taken along an arrow B-B in FIG.

FIG. 16 is a diagram taken along an arrow X-X in FIG. 10.

FIG. 17 is a perspective view illustrating a second space.

FIG. 18 is an enlarged view illustrating a member to cover a second intake port.

FIG. 19 is a plan view illustrating a relation between a cover included in the battery-powered forklift and the battery.

### DESCRIPTION OF EMBODIMENTS

A mode to implement (embodiment of) the present invention will be described with reference to the drawings.

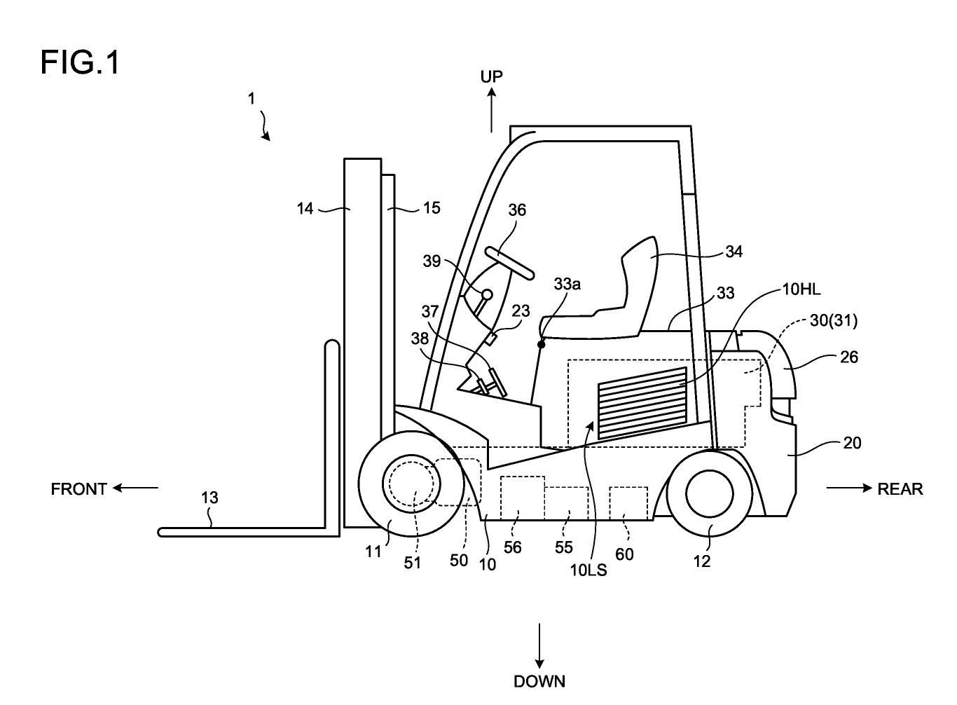

FIG. 1 is a diagram illustrating a work vehicle charge system according to the present embodiment. In the present embodiment, a battery-powered forklift 1 will be described as an example of a work vehicle, but the work vehicle is not limited thereto. For example, the work vehicle may be a work vehicle such as a wheel loader or an excavator driven by power obtained from a generator driven by power from a battery, an engine, or the like.

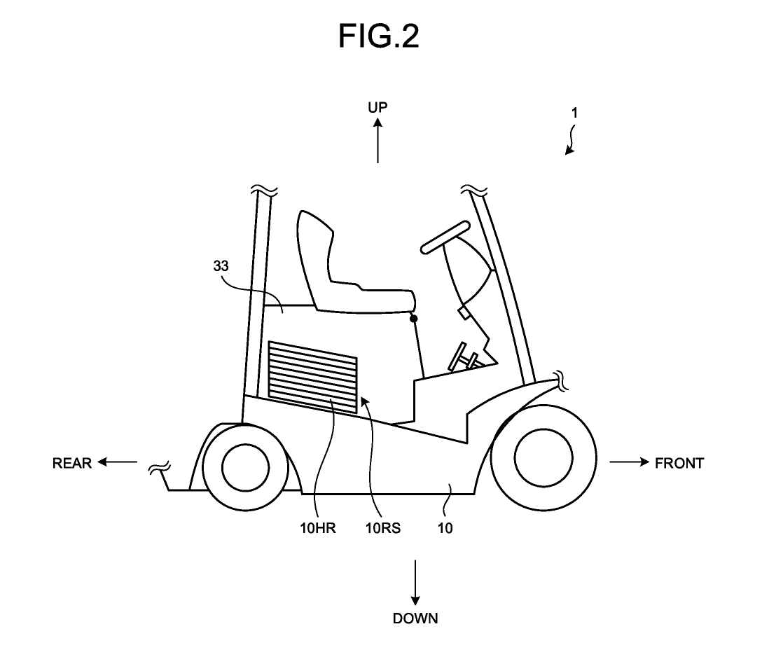

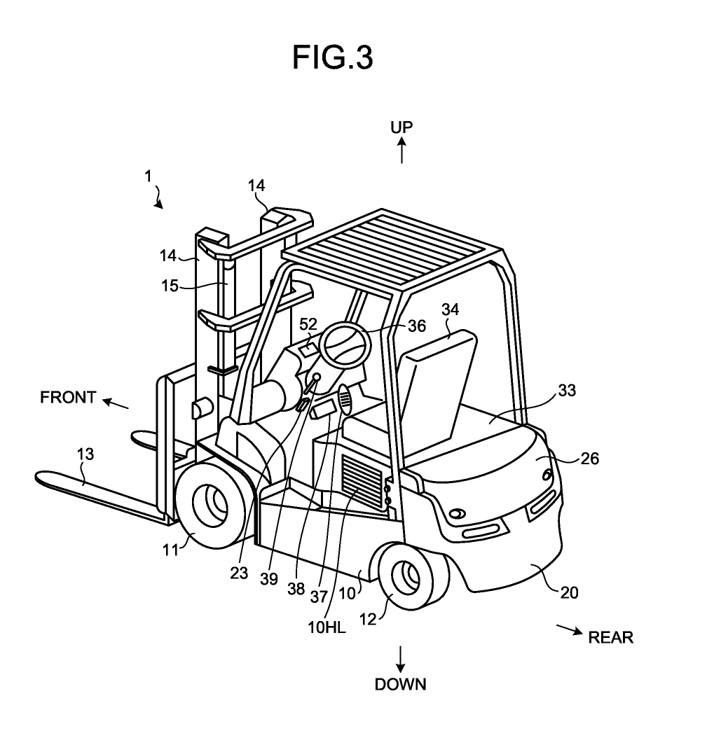

FIG. 1 is a side view illustrating the battery-powered forklift 1 according to a present embodiment in a state viewed from a left side. FIG. 2 is a side view illustrating a part of the battery-powered forklift 1 according to the present embodiment in a state viewed from a right side. FIG. 3 is a perspective view illustrating the battery-powered forklift 1 according to the present embodiment in a state viewed from obliquely above on a left rear side. In the following, note that a side provided with a fork 13 which is a work unit is a front side, and a side provided with a counter weight 20 is a rear side of the battery-powered forklift 1. In the case where the work vehicle is not a battery-powered forklift, a side facing a steering wheel 36 as a control device from a driver's seat 34 is the front side, and a side facing the driver's seat 34 from the steering wheel 36 is the rear side. In an excavator, wheel loader, etc., an operating lever to operate a work unit is also included as the control device, in addition to the steering wheel 36.

In the present embodiment, note that right and left with respect to the front side will be referred to as right and left. A horizontal direction is a width direction of a vehicle body 10 as a main body of the work vehicle. An upper side is the side orthogonal to a flat surface (ground plane) contacting at least three out of front wheels 11 and rear wheels 12, and further is the side facing a rotation central axis of the front wheel 11 or the rear wheel 12 from the ground plane. A lower side is the side facing the ground plane from the rotation central axis of the front wheel 11 or the rear wheel 12. An axis extending in a longitudinal direction of the vehicle body 10 and further passing a center in the width direction of the vehicle body 10 will be referred to as a longitudinal axis, and an axis orthogonal to the longitudinal axis, parallel to an installation plane, and directed in the horizontal direction of the vehicle body 10 will be referred to as an horizontal axis. An axis directed in a vertical direction of the vehicle body 10 will be referred to as a vertical axis. The vertical axis is orthogonal to both of the longitudinal axis and horizontal axis. In the following, a state viewed from above will be referred to as a planar view.

<Entire Structure of Battery-Powered Forklift 1>

The battery-powered forklift 1 includes front wheels 11 at respective corners on the front side of the vehicle body 10, and includes rear wheels 12 at respective corners on the rear side of the vehicle body 10. The battery-powered forklift 1 is made to travel by the front wheels 11 driven by a motor (traveling motor) 50 disposed on the rear side of the front wheels 11. More specifically, output of the traveling motor 50 is transmitted to both of the front wheels 11, 11 via a transmission gear 51 having a deceleration function, and drives these wheels.

In the present embodiment, a permanent magnet (PM) type, namely, a motor provided with a rotor including a permanent magnet can be used as the traveling motor 50. In the case of using the PM type motor as the traveling motor 50, any one of a surface permanent magnet (SPM) type and an interior permanent magnet (IPM) type may be adopted.

The fork 13 to perform loading and unloading is disposed on the front side of the vehicle body 10. The fork 13 is supported by a mast 14 disposed along the vertical direction. The fork 13 is moved up and down along the mast 14 by driving a mast cylinder 15 interposed in a space with the mast 14. The mast 14 is mounted on the vehicle body 10 in such a manner that a lower end portion thereof can rotate around the horizontal axis although not clearly illustrated. Further, the mast 14 includes a tilt cylinder not illustrated in a space with the vehicle body 10. The mast 14 can take a forward tilted posture or a rearward tilted posture with respect to the vehicle body 10 by driving the tilt cylinder.

The counter weight 20 is disposed at one end portion of the vehicle body 10 in the longitudinal direction, more specifically, at a rear end portion. In the present embodiment, the battery-powered forklift 1 is a counter balance forklift, but not limited thereto. The counter weight 20 is a weight to strike a balance in the case where the fork 13 supports a cargo. In the present embodiment, the counter weight 20 is manufactured by casting cast iron, but note that material and a manufacturing method for the counter weight 20 is not limited to the mentioned material and method. The counter weight 20 is disposed from a region above the rear wheels 12 to a region at the rear end of the vehicle body 10.

The battery-powered forklift 1 includes an accelerator pedal 37, a brake pedal 38, and a travel direction switching lever 39. The accelerator pedal 37 is an operating member to control output and a rotary direction of the traveling motor 50. The brake pedal 38 is an operating member to stop the battery-powered forklift 1. The travel direction switching lever 39 is an operating member to switch a travel direction of the battery-powered forklift 1 between frontward and rearward. The battery-powered forklift 1 includes a charge connector 23. The charge connector 23 is connected to a battery charger-side connector of a battery charger at the time of charging the work vehicle battery 30. When the charge connector 23 is not connected to the charger-side connector, a cap is attached to the charge connector 23 for water proof. In the following, the work vehicle battery 30 is conveniently referred to as the battery 30.

As illustrated in FIG. 3, the battery-powered forklift 1 includes a display panel 52 as a display device on the front side of the steering wheel 36. The display panel 52 includes an input unit to provide various kinds of settings relative to the battery-powered forklift 1, and a display unit to display information related to a state and the like of the battery-powered forklift 1. An operator of the battery-powered forklift 1 executes various kinds of settings for the battery-powered forklift 1 via the display panel 52. Information related to a state and the like of the battery-powered forklift 1 to be displayed on the display unit of the display panel 52 includes, for example, a state of the battery 30, hydraulic pressure of hydraulic oil supplied to the mast cylinder 15, and so on. The hydraulic oil is supplied from a hydraulic pump 56 driven by a cargo handling motor 55. An in-vehicle controller 60 controls the traveling motor 50 and the cargo handling motor 55.

The battery 30 includes a plurality of battery cells and a battery case 31 that stores the plurality of battery cells. The battery 30 is mounted on the vehicle body 10. In the present embodiment, the battery 30 is covered with a battery cover 33 of the vehicle body 10. The battery cover 33 is rotated around a support shaft 33a In the case of mounting the battery 30 on the vehicle body 10 or removing the battery 30 from the vehicle body 10, the battery cover 33 is rotated around a shaft center of the support shaft 33a together with the driver's seat 34 to open an upper side of the battery 30.

In the present embodiment, as illustrated in FIG. 1, a part of the battery 30 is stored in the counter weight 20. The counter weight 20 is opened to the upper side of the vehicle body 10, and a part of the battery 30 is stored in the opened portion. The counter weight 20 has at least a part of the opened portion covered with a cover 26. In the present embodiment, the cover 26 is made of resin, but the cover 26 is not limited thereto and may be made of metal.

When the battery 30 is mounted on the vehicle body 10, the battery 30 is surrounded by the battery cover 33, counter weight 20, and cover 26. Thus, the battery 30 is mounted inside the vehicle body 10. Since the battery cells included in the battery 30 generate heat during charge, it is necessary to exhaust the heat of the battery 30 to the outside of the vehicle body 10 and introduce cooling air from the outside of the vehicle body 10. Therefore, the vehicle body 10 includes, at one side portion in the width direction, more specifically, at a right side portion 10RS, a first hole 10HR that connects the inside and the outside of the vehicle body 10, and includes, at the other side portion in the width direction, more specifically, at a left side portion 10LS, a second hole 10HL that connects the inside and the outside of the vehicle body 10. In the present embodiment, the first hole 10HR and second hole 10HL are disposed on the both sides of the battery cover 33 in the width direction, but these holes may also be disposed at places other than the battery cover 33.

Through the first hole 10HR and the second hole 10HL, the air comes in and out between the inside and outside of the vehicle body 10. Therefore, heat of the battery 30 is exhausted to the outside of the vehicle body 10. Further, the battery 30 is cooled by the air coming into the vehicle body 10 from the outside of the vehicle body 10 through the first hole 10HR and second hole 10HL. Next, structure of the counter weight 20 will be described.

<Structure of Counter Weight 20>

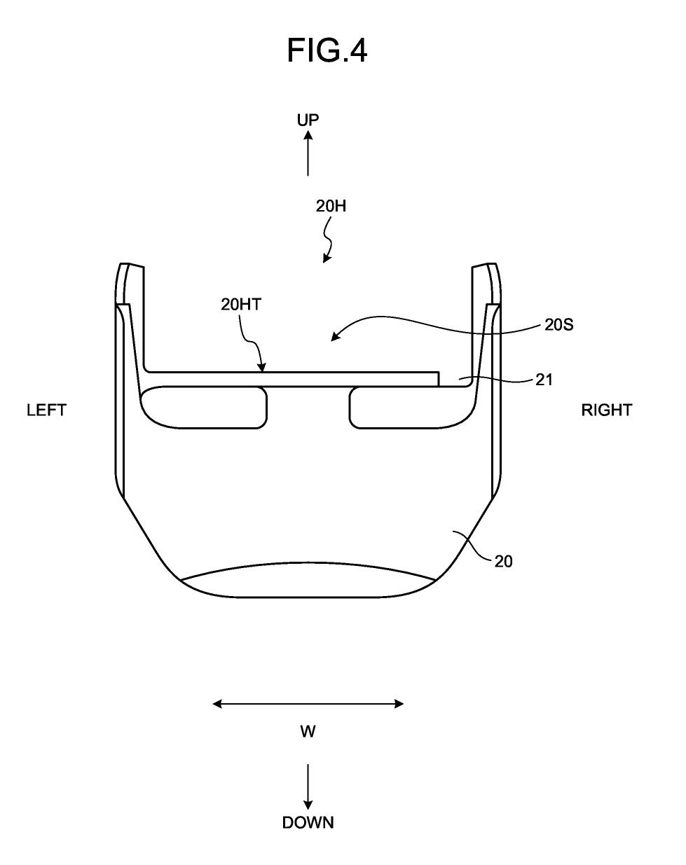

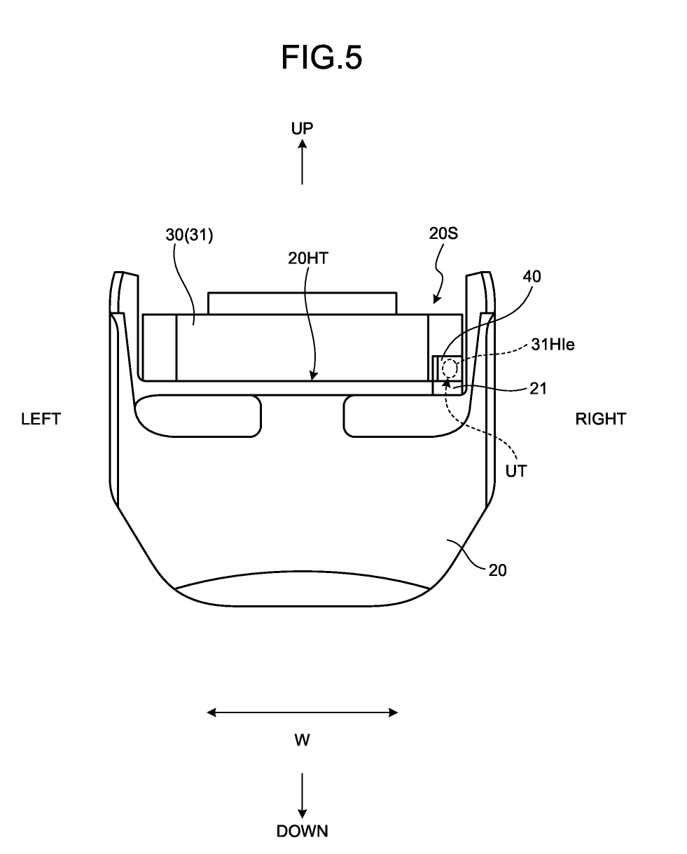

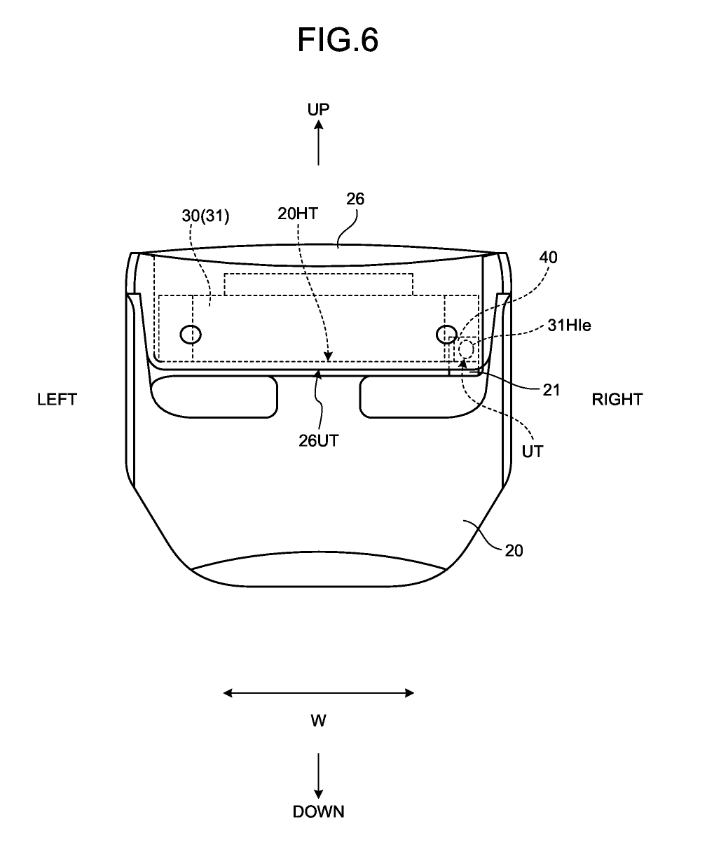

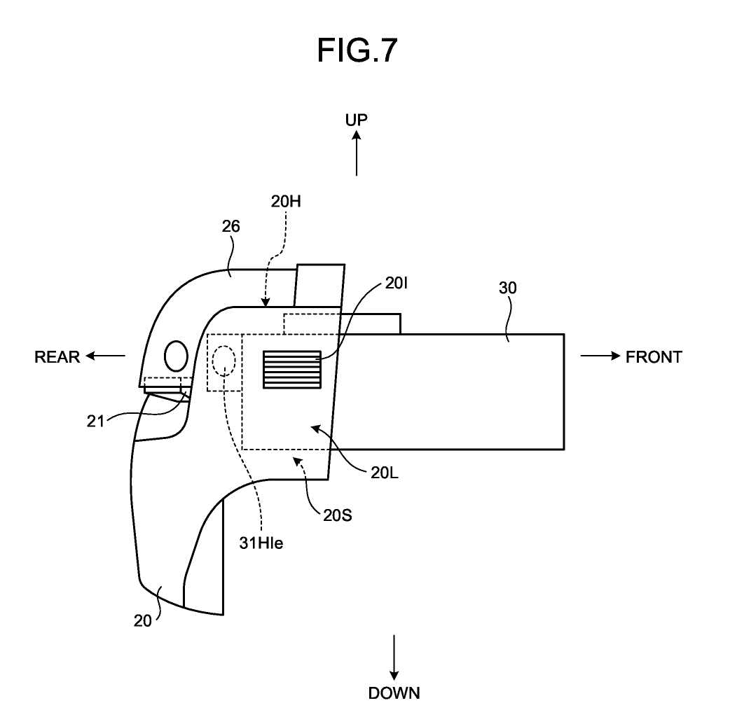

FIGS. 4 to 6 are views illustrating the counter weight 20 when viewed from the rear side of the battery-powered forklift 1. FIG. 4 illustrates a state in which a part of the battery 30 is not stored in the counter weight 20, and FIG. 5 illustrates a state in which a part of the battery 30 is stored in the counter weight 20. FIG. 6 illustrates a state in which a part of the battery 30 is stored in the counter weight 20 and further the cover 26 covers the opened portion of the counter weight 20. FIG. 7 is a side view illustrating a relation between the counter weight 20 and the battery 30. FIG. 7 illustrates the counter weight 20 and the battery 30 in a state viewed from the left side of the battery-powered forklift 1.

The counter weight 20 includes an opened portion 20H opened to the upper side of the battery-powered forklift 1 illustrated in FIG. 1. The opened portion at the counter weight 20 is to be a storage unit 20S to store a part of the battery 30. In the case where the battery 30 is mounted on the vehicle body 10, a part of the battery 30 is stored in the storage unit 20S from the opened portion 20H of the counter weight 20.

As illustrated in FIGS. 4 and 5, the counter weight 20 includes a passage 21 that connects the storage unit 20S to the outside of the counter weight 20. The passage 21 is disposed at a part of the counter weight 20. In the present embodiment, the passage 21 connects the storage unit 20S of the counter weight 20 to the rear side of the counter weight 20 by cutting off a part of the counter weight 20, more specifically, a part of a portion overlapping with the cover 26. In the present embodiment, the portion overlapping with the cover 26 in the counter weight 20 is partly cut off in the width direction W and in a downward direction from an end portion 20HT of the opened portion 20H side. The cut-off portion in the counter weight 20 is to be the passage 21.

Since a part of the battery 30 stored in the storage unit 20S of the counter weight 20 is surrounded by the counter weight 20 and the cover 26, temperature tends to increase. Further, a cooling medium such as the air tends to stagnate at the portion surrounded by the counter weight 20 and the cover 26, and the battery 30 is hardly cooled. The passage 21 allows the air to pass from the outside of the counter weight 20 to the storage unit 20S in a state that the opened portion 20H of the counter weight 20 is covered with the cover 26. Therefore, the battery 30 stored in the counter weight 20 is cooled by the air flowing into the storage unit 20S from the passage 21, thereby achieving to cool the battery 30 even in the case where the battery 30 is mounted at a portion where heat is hardly radiated. As a result, temperature increase of the battery 30 can be prevented during charge.

In the present embodiment, the passage 21 is disposed on the right side in the width direction W of the counter weight 20, but a position of the passage 21 is not limited thereto. For example, the passage 21 may be disposed at a center in the width direction W of the counter weight 20, or may be disposed on the left side in the width direction W. In the present embodiment, the number of the passage 21 is one, but in this case, water entrance from the outside of the battery-powered forklift 1 can be prevented. In the present embodiment, a plurality of passages 21 may be provided as well. In the case where the counter weight 20 includes the plurality of passages 21, an area where gas passes is increased. Therefore, a large amount of air flows into the storage unit 20S. As a result, the battery 30 is more cooled.

In the case where an opening of the passage 21 can be viewed from the outside of the battery-powered forklift 1, external appearance may be deteriorated. In the present embodiment, when the cover 26 covers the opened portion 20H of the counter weight 20 as illustrated in FIG. 6, the cover overlaps with a part of the opening of the passage 21 on the outside of the counter weight 20. With this structure, the opening of the passage 21 can be hardly seen when viewed from the rear side of the battery-powered forklift 1. As a result, the appearance of the battery-powered forklift 1 is prevented from deterioration.

In the present embodiment, when the cover 26 covers the opened portion 20H of the counter weight 20, clearance is formed between a lower end 26UT of the cover 26 and the opening of the passage 21 on the outside of the counter weight 20. With this structure, the air on the outside flows into the storage unit 20S of the counter weight 20 through the mentioned clearance and the passage 21, thereby surely cooling the battery 30.

In the present embodiment, a part of the portion of the battery case 31 stored in the counter weight 20 includes a hole 31HIe. The air flows from the hole 31HIe into the battery case 31, thereby cooling the battery cells stored in the battery case 31. In the following, the hole 31HIe will be conveniently referred to as an intake port 31HIe. In the present embodiment, the intake port 31HIe is disposed at a part of a portion to be located on the rear side when the battery 30 is mounted on the vehicle body 10. More specifically, the intake port 31HIe is disposed on right rear side of the battery case 31.

In the present embodiment, when the battery 30 is mounted on the vehicle body 10 of the battery-powered forklift 1 as illustrated in FIGS. 5 and 6, the position of the passage 21 is aligned with the position of the intake port 31HIe in the width direction W of the battery-powered forklift 1. With this structure, the air having flown into the storage unit 20S via the passage 21 cools the battery cells by flowing into the battery case 31 from the intake port 31HIe of the battery case 31. Therefore, the battery 30 can cool the battery cells stored at a portion of the counter weight 20 where the battery cells are hardly cooled inside.

In the present embodiment, preferably, the passage 21 of the counter weight 20 and the intake port 31HIe overlap at least partly in the width direction of the battery-powered forklift 1 as illustrated in FIGS. 5 and 6. With this structure, the air having flown into the storage unit 20S from the passage 21 effectively flows into the intake port 31HIe of the battery case 31, thereby achieving to cool the battery cells inside the battery case 31.

As illustrated in FIG. 5, preferably, a lower end UT of the intake port 31HIe is positioned higher than an upper end of the passage 21. The upper end of the passage 21 is the end portion 20HT on the opened portion 20H side of the counter weight 20. Since the lower end UT of the intake port 31HIe is positioned higher than the upper end of the passage 21, water having entered the storage unit 20S from the passage 21 can be prevented from entering into the battery case 31 from the intake port 31HIe. Further, since the lower end UT of the intake port 31HIe is positioned higher than the upper end of the passage 21, there is a merit that the intake port 31HIe can be hardly seen from the clearance between the cover 26 and the opening of the passage 21 when the counter weight 20 is viewed from the rear side.

As illustrated in FIGS. 5 and 6, the battery case 31 includes a member 40 that covers the intake port 31HIe. The member 40 includes an opening to allow gas, the air in the present embodiment, to flow into the intake port 31HIe although the member 40 will be described later. The air having flown into the storage unit 20S passes the opening of the member 40, and then flows into the battery case 31 from the intake port 31HIe. The member 40 can prevent the water from entering the inside of the battery case 31 from the intake port 31HIe. Therefore, deterioration of water proof property of the battery case 31 can be prevented.

As illustrated in FIG. 7, the counter weight 20 includes a hole 201 at a left side portion 20L. The hole 201 connects the storage unit 20S to the outside of the counter weight 20. With this structure, the air flows into the storage unit 20S from the hole 201, thereby cooling the portion of the battery 30 stored in the counter weight 20. The counter weight 20 may include a hole that connects the storage unit 20S to the outside of the counter weight 20 not only at the left side portion 20L but also at a right side portion as well. With this structure, an amount of the air flowing into the storage unit 20S or flowing out from the storage unit 20S can be increased, thereby effectively ventilating the air inside the storage unit 20S. As a result, cooling efficiency at the portion of the battery 30 stored in the counter weight 20 is improved. Next, the battery 30 will be described more in detail.

<Structure of Battery 30>

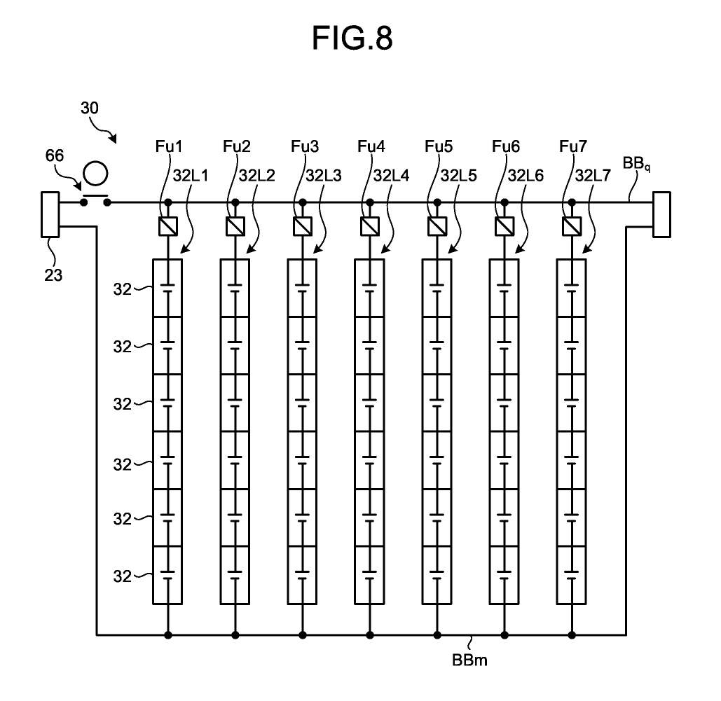

FIG. 8 is an explanatory diagram for the battery 30 included in the battery-powered forklift 1 according to the present embodiment. The battery 30 includes a plurality of battery cells 32. In the present embodiment, the battery cell 32 is a valve regulated storage battery (e.g., lead storage battery). This kind of battery cell 32 is suitable for fast charge. Each of the battery cells 32 has voltage across terminals of 12 V. In the present embodiment, the plurality of battery cells 32 is connected in series (six in this example), and a plurality of battery cell groups 32L1, 32L2, 32L3, 32L4, 32L5, 32L6, 32L7 is formed (seven in this example). Further, the respective battery cell groups 32L1, 32L2, 32L3, 32L4, 32L5, 32L6, 32L7 are connected in parallel by copper bus bars BBp, BBm, for example. Thus, the battery 30 is a parallel battery pack in which the plurality of battery cell groups 32L1, 32L2, 32L3, 32L4, 32L5, 32L6, 32L7 is connected in parallel.

The bus bar BBm electrically connects negative side terminals of the battery cell groups 32L1, 32L2, 32L3, 32L4, 32L5, 32L6, 32L7, and the bus bar BBp electrically connects positive side terminals of the battery cell groups 32L1, 32L2, 32L3, 32L4, 32L5, 32L6, 32L7. Between the bus bar BBp and the respective battery cell groups 32L1, 32L2, 32L3, 32L4, 32L5, 32L6, 32L7, fuses Fu1, Fu2, Fu3, Fu4, Fu5, Fu6, Fu7 are connected. In other words, the terminals of the battery cells 32 included in the respective battery cell groups 32L1, 32L2, 32L3, 32L4, 32L5, 32L6, 32L7 are connected to the fuses Fu1, Fu2, Fu3, Fu4, Fu5, Fu6, Fu7. The bus bar BBm and bus bar BBp are connected to the charge connector 23. A contactor 66 is disposed between the bus bar BBp and the charge connector 23.

Since the battery 30 is the parallel battery pack, when temperature is varied between the respective battery cell groups 32L1, 32L2, 32L3, 32L4, 32L5, 32L6, 32L7, internal resistance of the battery cells 32 having high temperature is decreased, and current tends to flow easily. As a result, charging rates of the respective battery cell groups 32L1, 32L2, 32L3, 32L4, 32L5, 32L6, 32L7 may be varied or durability of the battery cell 32 may be deteriorated. Generally, such variation of the charging rates and deterioration of durability are prevented by controlling current flow in the respective battery cell groups 32L1, 32L2, 32L3, 32L4, 32L5, 32L6, 32L7 during charge.

<Battery 30 and Battery Case 31>

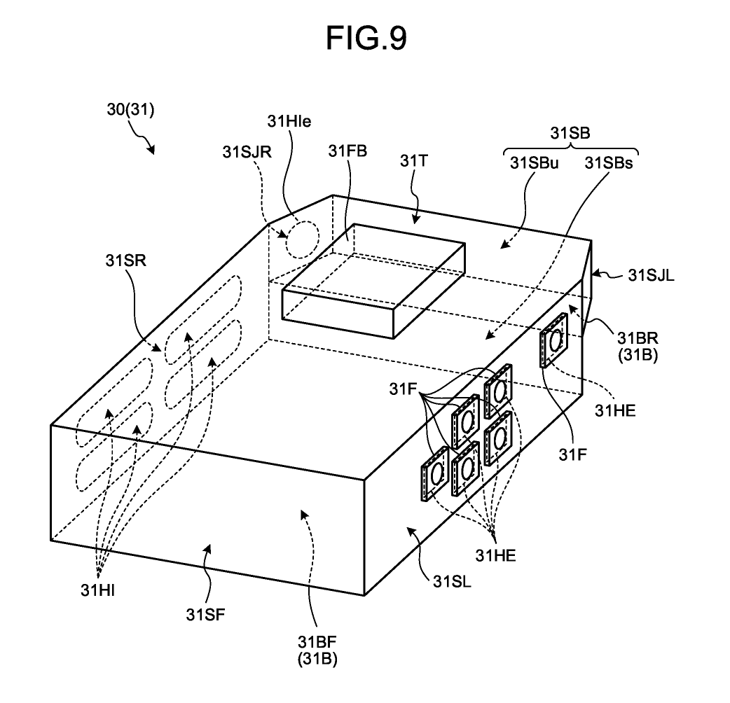

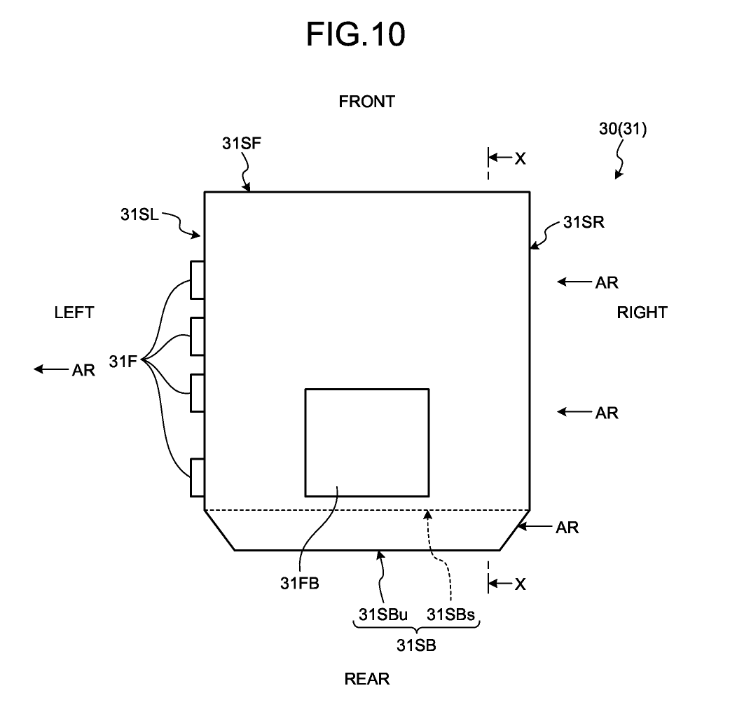

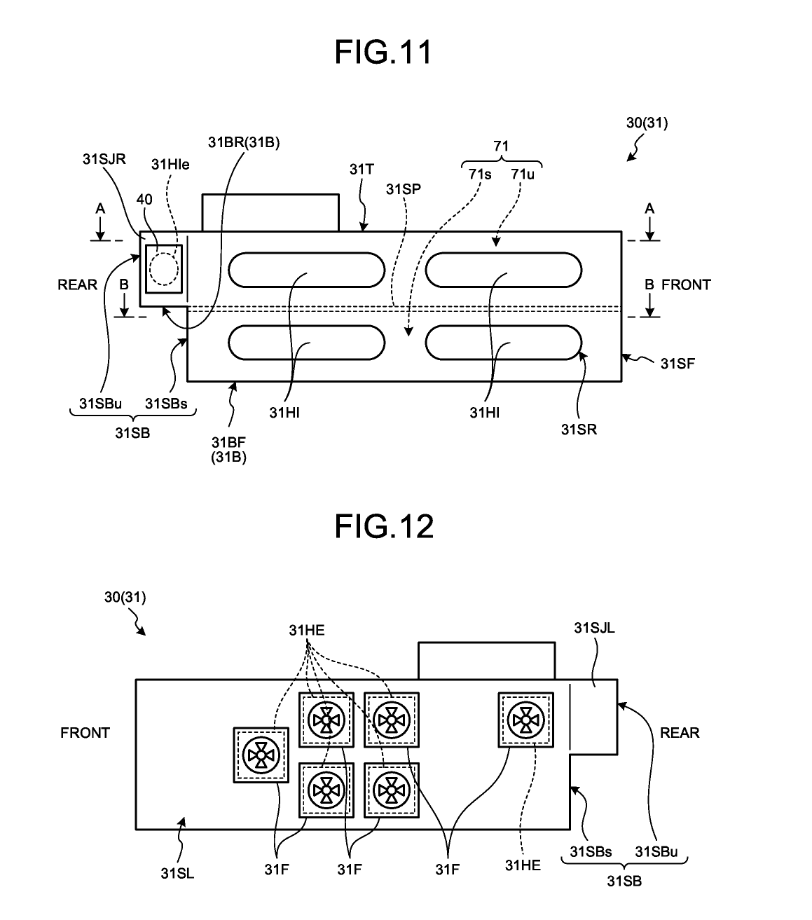

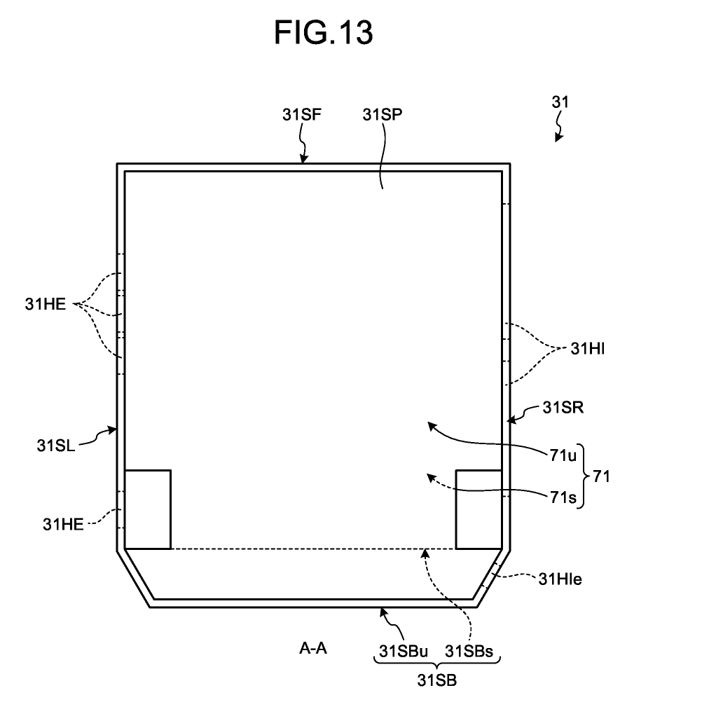

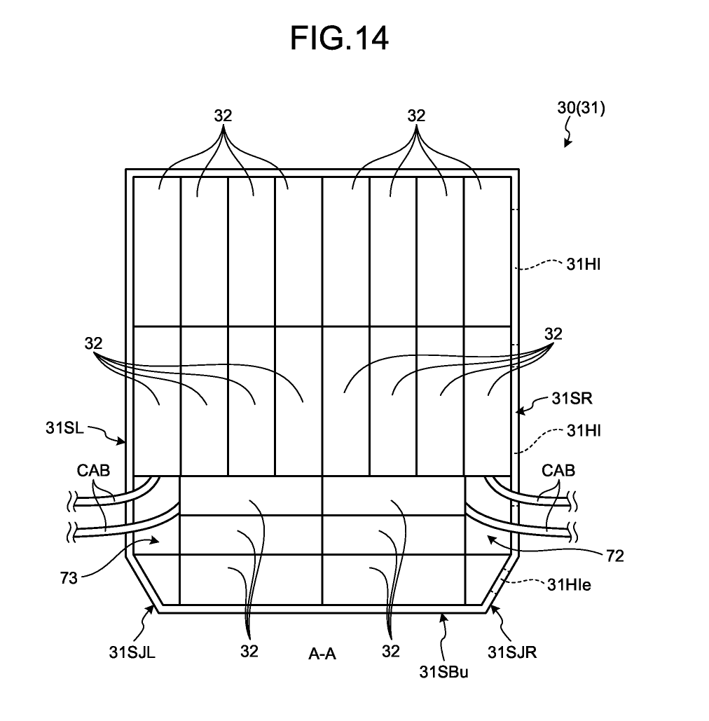

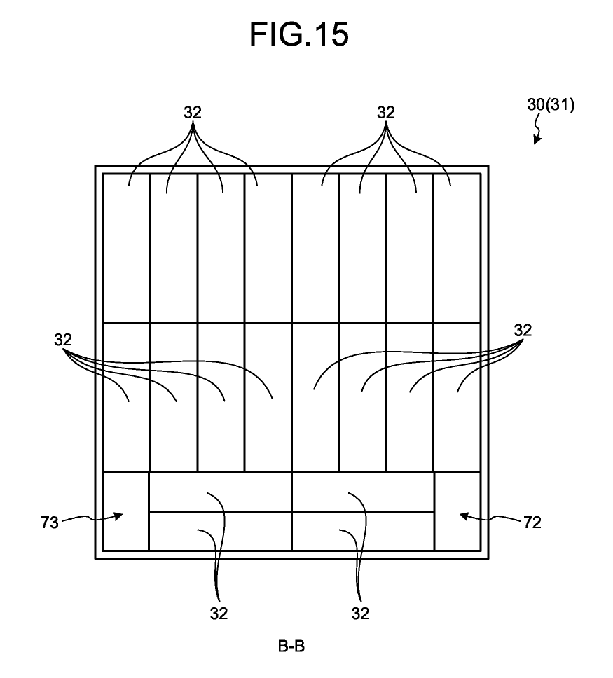

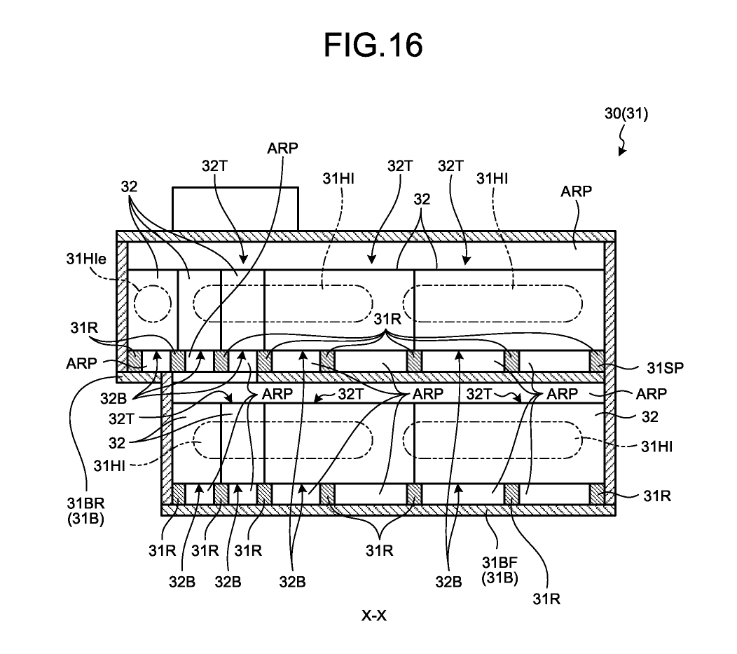

FIG. 9 is a perspective view illustrating the battery 30 and the battery case 31 according to the present embodiment. FIG. 10 is a plan view illustrating the battery 30 and the battery case 31 according to the present embodiment. FIG. 11 is a right side view illustrating the battery 30 and the battery case 31 according to the present embodiment. FIG. 12 is a left side view illustrating the battery 30 and the battery case 31 according to the present embodiment. FIGS. 13 and 14 are diagrams taken along an arrow A-A in FIG. 11. FIG. 13 illustrates a state in which the battery cells 32 are not stored in the battery case 31. FIG. 14 illustrates a state in which the battery cells 32 are stored inside the battery case 31. FIG. 15 is a diagram taken along an arrow B-B in FIG. 11. FIG. 16 is a diagram taken along an arrow X-X in FIG. 10.

In the battery 30, the above-described plurality of battery cell 32 is stored inside the battery case 31. The battery case 31 includes a bottom portion 31B, a top portion 31T facing the bottom portion 31B, and side portions 31SF, 31SB, 31SL, 31SR connecting the bottom portion 31B to the top portion 31T. In the present embodiment, the battery case 31 can be manufactured by cutting and bending a metal plate and then joining by welding, and using a rivet, a screw, and so on. The material and a manufacturing method for the battery case 30 are not limited thereto.

When the battery 30 is mounted on the vehicle body 10 of the battery-powered forklift 1, the side portion 31SF is located on a front side, the side portion 31SR on a right side, the side portion 31SL on a left side, and the side portion 31SB on a rear side. The side portion 31SB on the rear side includes a lower side portion 31SBs and an upper side portion 31SBu. The bottom portion 31B includes a front bottom portion 31BF and a rear bottom portion 31BR. The lower side portion 31SBs extends from a rear end of the front bottom portion 31BF in a direction orthogonal to the front bottom portion 31BF which is a plate-like member. The rear bottom portion 31BR, which is a plate-like member, extends from an upper end of the lower side portion 31SBs in a direction orthogonal to the lower side portion 31SBs. The upper side portion 31SBu, which is a plate-like base metal, extends from a rear end of the rear bottom portion 31BR in a direction orthogonal to the rear bottom portion 31BR. The left side portion 31SL and the upper side portion 31SBu on the rear side are connected by a left connecting portion 31SJL which is a plate-like member. The right side portion 31SR and the upper side portion 31SBu on the rear side are connected by a right connecting portion 31SJR which is a plate-like member. Both the left connecting portion 31SJL and the right connecting portion 31SJR constitute some of the side portions.

With this structure, a portion formed by the upper side portion 31SBu on the rear side, left connecting portion 31SJL, right connecting portion 31SJR, rear bottom portion 31BR, and the top portion 31T projects rearward from the lower side portion 31SBs.

In the present embodiment, the side portion 31SL and side portion 31SR are respectively plate-like members and orthogonal to the side portion 31SF which is a plate-like member. The side portion 31SL, side portion 31SR, and side portion 31SF are orthogonal to the top portion 31T and the front bottom portion 31BF which are plate-like members. The upper side portion 31SBu on the rear side is orthogonal to the top portion 31T. The left connecting portion 31SJL and the right connecting portion 31SJR are orthogonal to the top portion 31T and the rear bottom portion 31BR.

The battery case 31 stores the plurality of battery cells 32 in a first space surrounded by the top portion 31T, bottom portion 31B, side portions 31SF, 31SB, 31SL, 31SR, left connecting portion 31SJL, and right connecting portion 31SJR. In the present embodiment, the battery case 31 stores forty-two battery cells 32.

In the present embodiment, as illustrated in FIG. 11, the battery case 31 includes a sectioning member 31SP that sections the first space between the top portion 31T and the bottom portion 31B, more specifically, the top portion 31T and the front bottom portion 31BF. As illustrated in FIGS. 11 and 13, a first space 71 includes an upper first space 71u positioned higher than the sectioning member 31SP and a lower first space 71s positioned below the sectioning member 31SP.

FIG. 14 illustrates a state in which the plurality of battery cells 32 is stored in the upper first space 71u. As illustrated in FIG. 14, twenty-two battery cells 32 are stored in the upper first space 71u. FIG. 15 illustrates a state in which the plurality of battery cells 32 is stored in the lower first space 71s. As illustrated in FIG. 15, twenty battery cells 32 are stored in the lower first space 71s. Therefore, forty-two battery cells 32 are stored in the first space 71 of the battery cell 32.

The battery case 31 has a second space 72 and a third space 73 described later disposed on a side located on the rear side when mounted on the battery-powered forklift 1. Therefore, the number of the battery cells 32 stored in the first space 71 per unit volume is fewer on the side located on the rear side than a side located on the front side when mounted on the battery-powered forklift 1. With this structure, the side located on the rear side when mounted on the battery-powered forklift 1, more specifically, the side stored in the storage unit 20S of the counter weight 20 has a less heat generation amount per unit volume than the side located on the front side does. As a result, the battery 30 can suppress the heat generation amount at the portion stored in the storage unit 20S of the counter weight 20.

When the battery 30 is mounted on the vehicle body 10 of the battery-powered forklift 1, a size of the upper side portion 31SBu in the width direction of the battery-powered forklift 1 is smaller than a distance between the right side portion 31SR and the left side portion 31SL. The right connecting portion 31SJR connecting the right side portion 31SR to the upper side portion 31SBu is inclined leftward more than the right side portion 31SR. The left connecting portion 31SJL connecting the left side portion 31SL to the upper side portion 31SBu is inclined rightward more than the left side portion 31SL. With this structure, the battery case 31 has a shape in which a portion located on the rear side of the battery-powered forklift 1 is narrowed in a state viewed from above.

Note that the shapes of the right connecting portion 31SJR and the left connecting portion 31SJL are not limited to those of the present embodiment. For example, the right connecting portion 31SJR and the left connecting portion 31SJL may be formed stepwise or may be formed in a curved surface. Further, the upper side portion 31SBu, right side portion 31SR, and left side portion 31SL may be directly and orthogonally connected.

The battery case 31 has a storage case 31FB to store a safety circuit mounted on the top portion 31T. The above-described fuses Fu1, Fu2, Fu3, Fu4, Fu5, Fu6, Fu1 and the contactor 66 are stored in the storage case 31FB.

When the battery 30 is mounted on the battery-powered forklift 1, the battery 30 has the side portion 31SF of the battery case 31 facing the front side and the side portion 31SB of the battery case 31 facing the rear side. Further, the battery 30 has the side portion 31SL of the battery case 31 facing the left side and the side portion 31SR of the battery case 31 facing the right side. The front side and the rear side correspond to the front side and rear side of the battery-powered forklift 1 illustrated in FIGS. 1 and 3. In other words, when the battery 30 is mounted on the battery-powered forklift 1, the side portion 31SF faces the front side and the side portion 31SB faces the rear side.

As illustrated in FIGS. 9 and 11, the right side portion 31SR includes an intake port 31HI opened to itself. In the following, the intake port 31HI will be conveniently referred to as a first intake port 31HI. When the battery 30 is mounted on the battery-powered forklift 1, the right side portion 31SR is the portion to be located in the width direction W of the battery-powered forklift 1, more specifically, the right side in the width direction W. The first intake port 31HI introduces gas, the air in the present embodiment, into the battery case 31. In the present embodiment, the side portion 31SR includes a plurality of first intake ports 31HI (four in the present embodiment), but note that the number of the first intake ports 31HI is not limited to four. In the present embodiment, the first intake port 31HI has a long-hole shape, but the shape of the first intake port 31HI is not limited thereto.

At least some of the first intake ports 31HI overlap with the first hole 10HR illustrated in FIG. 2. With this structure, the battery 30 can introduce, into the battery case 31, the air in the outside of the battery-powered forklift 1 via the first hole 10HR and the first intake holes 31HI.

As illustrated in FIG. 14, the second space 72 is formed between the side portions of the battery case 31, in the present embodiment between the right side portion 31SR, right connecting portion 31SJR, and some battery cells 32 out of the plurality of battery cells 32. The second space 72 is a part of the above-described first space 71. In the present embodiment, the first space 71 is sectioned by the sectioning member 31SP illustrated in FIGS. 11 and 13.

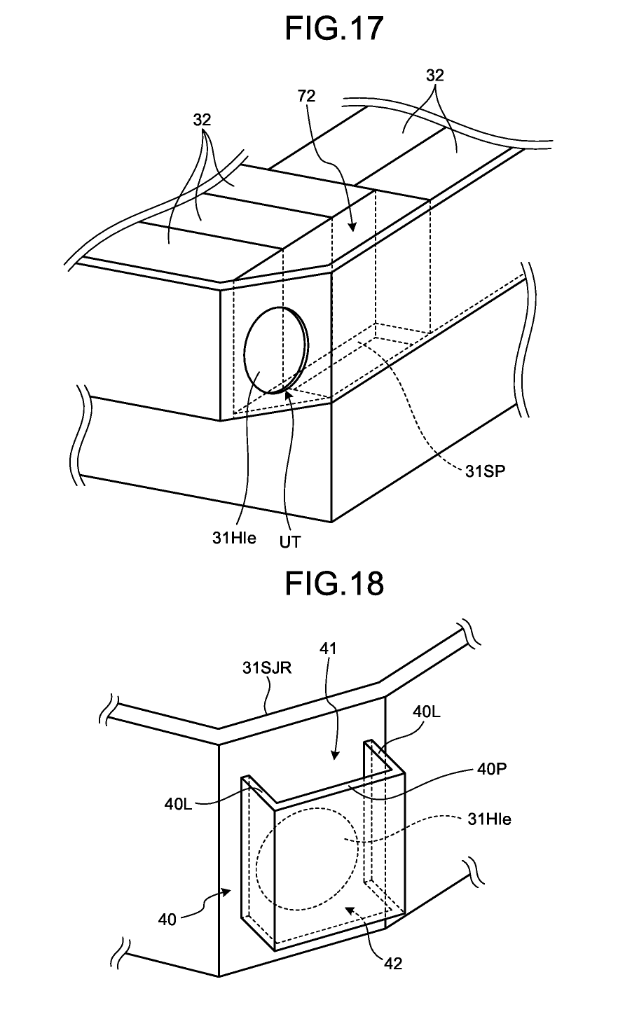

FIG. 17 is a perspective view illustrating the second space 72. The second space 72 connects the first spaces sectioned by the sectioning member 31SP, more specifically, the upper first space 71u and the lower first space 71s. In the second space 72, a cable CAB that mutually and electrically connects the battery cells 32 stored in the upper first space 71u and the lower first space 71s respectively is passed through.

Among the side portions of the battery case 31, the portions positioned more on the rear side of the battery-powered forklift 1 than the first intake port 31HI when the battery 30 is mounted on the battery-powered forklift 1 includes the hole 31HIe, namely, the intake port 31HIe opened. In the present embodiment, the intake port 31HIe is opened at the right connecting portion 31SJR. In the following, the intake port 31HIe will be conveniently referred to as a second intake port 31HIe. The second intake port 31HIe connects the second space 72 to the outside of the battery case 31, and introduces gas, the air in the present embodiment, into the second space 72.

The second intake port 31HIe introduces the air into the second space 72 having a certain level of volume, thereby easily forming an air flow. In the present embodiment, the second intake port 31HIe has a round shape, but not limited thereto. In the present embodiment, a lower end of the second intake port 31HIe is positioned higher than the sectioning member 31SP. With this structure, water entrance from the second intake port 31HIe is prevented.

FIG. 18 is an enlarged view illustrating a member 40 to cover the second intake port 31HIe. The battery case 31 includes the member 40 to cover the second intake port 31HIe. The member 40 is mounted on the right connecting portion 31SJR where the second intake port 31HIe is disposed. The member 40 includes two leg portions 40L, 40L attached to the right connecting portion 31SJR, and a connecting portion 40P that connects the two leg portions 40L, 40L and further covers the second intake port 31HIe. The connecting portion 40P is a plate-like member, and the two leg portions 40L, 40L spaced apart project from a surface of the connecting portion 40P. The two leg portions 40L, 40L have end portions which are positioned on the opposite side of the connecting portion 40P and attached to the right connecting portion 31SJR. The portion surrounded by the two leg portions 40L, 40L and the connecting portion 40P includes two opened portions 41, 42. The connecting portion 40P covers the second intake port 31HIe, thereby preventing water entrance from the second intake port 31HIe. The air flows into the second intake port 31HIe via the opened portions 41, 42. In the present embodiment, the opened portion 41 is disposed above the second intake port 31HIe, and the opened portion 42 is disposed below the second intake port 31HIe, but the opened portions 41, 42 may be disposed on both sides in a direction orthogonal to the vertical direction. The member 40 is manufactured by bending a metal plate, for example, but the material and manufacturing method for the member 40 are not limited thereto.

The third space 73 is formed between the side portions of the battery case 31, in the present embodiment, the left side portion 31SL, left connecting portion 31SJL, and some battery cells 32 out of the plurality of battery cells 32. The third space 73 is a part of the above-described first space 71, and formed at a position different from the second space 72. Some of a plurality of exhaust ports 31HE, in the present embodiment, the exhaust port 31HE closest to the left connecting portion 31SJL is opened to the third space 73. With this configuration, the air inside the third space 73 is exhausted from the exhaust port 31HE.

At least some of the exhaust ports 31HE overlap with the second hole 10HL illustrated in FIG. 1. With this structure, the battery 30 can exhaust the air inside the battery case 31 to the outside of the battery-powered forklift 1 via the exhaust ports 31HE and the second hole 10HL.

The third space 73 connects the first spaces sectioned by the sectioning member 31SP, namely, connects the upper first space 71u to the lower first space 71s. In the third space 73, a cable CAB that mutually and electrically connects the battery cells 32 stored in the upper first space 71u and the lower first space 71s respectively is passed through.

The second space 72 is disposed on the side, out of the side portions of the battery case 31, where the first intake ports 31HI are opened. The third space 73 is disposed on the side, out of the side portions of the battery case 31, where the exhaust ports 31HE are opened. In other words, the second space 72 and the third space 73 are disposed on both sides in the horizontal direction, namely, the width direction of the battery 30. With this arrangement, the battery 30 becomes symmetric relative to the longitudinal axis when the battery 30 is mounted on the battery-powered forklift 1, thereby suppressing deterioration of balance in the width direction of the battery-powered forklift 1.

As illustrated in FIGS. 9 and 12, the side portion facing the side portion 31SR where the first intake ports 31HI are opened, namely, the left side portion 31SL includes the exhaust ports 31HE opened to itself. The exhaust ports 31HE exhaust the air introduced into the battery case 31. In the present embodiment, the side portion 31SL includes the plurality of the exhaust ports 31HE (six in the present example), but note that the number of the exhaust ports 31HE is not limited to six.

The battery case 31 includes a fan 31F. The fan 31F exhausts gas from the inside of the battery case 31 after introducing the gas into the battery case 31 from the first intake ports 31HI and the second intake port 31HIe and allows the gas to flow contacting upper surfaces and lower surfaces of the plurality of battery cells 32. In the present embodiment, the battery case 31 includes a plurality of the fans 31F (six fans in the present example). Note that the number of the fans 31F is not limited to six. The fans 31F are attached to the exhaust ports 31HE respectively. With this configuration, the plurality of fans 31F sucks the gas from the inside of the battery case 31, and exhausts the gas to the outside from the exhaust ports 31HE. Since the fans 31F suck the gas from the inside of the battery case 31, a gas flow directed to the exhaust ports 31HE from the first intake ports 31HI and second intake port 31HIe can be stably formed inside the battery case 31.

The fans 31F are controlled by the in-vehicle controller 60 illustrated in FIG. 1. In the present embodiment, the in-vehicle controller 60 cools the plurality of battery cells 32 by sucking the gas from the inside of the battery case 31 at least while charging the plurality of battery cells 32 included in the battery 30. With this structure, variation of the temperature in the respective battery cells 32 during charge can be suppressed. As a result, variation of charging rates can be prevented and deterioration of durability of the battery cells 32 can be suppressed. In the present embodiment, the in-vehicle controller 60 further suppresses temperature increase of the battery cells 32 by sucking the gas from the inside of the battery case 31 also while discharging the plurality of battery cells 32 included in the battery 30.

When the plurality of fans 31F exhausts the gas from the inside of the battery case 31, pressure inside the battery case 31 becomes lower than the outside. Due to this, the air is introduced into the battery case 31 from the first intake ports 31HI and second intake port 31HIe. In the present embodiment, the gas is introduced into the inside from the right side of the battery case 31, and exhausted from the left side as indicated by an arrow AR in FIG. 10. With this structure, the plurality of battery cells 32 stored inside the battery case 31 is cooled.

According to the relation between the battery-powered forklift 1 and the vehicle body 10 illustrated in FIGS. 1 to 3, the first intake ports 31HI and the second intake port 31HIe are disposed on one side in the width direction W of the battery-powered forklift 1 and the exhaust ports 31HE are disposed on the other side in the width direction W. In the present embodiment, the first intake ports 31HI and the second intake port 31HIe are disposed on the right side of the vehicle body 10, and the exhaust ports 31HE are disposed on the left side of the vehicle body 10. The air is introduced into the battery case 31 from the right side of the vehicle body 10 and exhausted from the left side. Since the fans 31F are attached to the exhaust ports 31HE, the fans 31F are disposed on the left side of the vehicle body 10. Therefore, size increase in the longitudinal direction of the vehicle body 10 caused by attaching the fans 31F to the battery case 31 can be prevented.

As illustrated in FIG. 16, in the present embodiment, the battery case 31 includes the sectioning member 31SP that sections the inside of the battery case 31 between the top portion 31T and the bottom portion 31B. The plurality of battery cells 32 is disposed between the top portion 31T and the sectioning member 31SP and between the sectioning member 31SP and the bottom portion 31B respectively. The sectioning member 31SP is a plate-like member. The sectioning member 31SP is disposed inside the respective side portions 31SF, 31SB, 31SL, 31SR of the battery case 31.

The battery 30 includes a plurality of crosspieces 31R as a plurality of bar-shaped members extending from the first intake ports 31HI and the second intake port 31HIe illustrated in FIGS. 9, 11, and 13 to the exhaust ports 31HE illustrated in FIGS. 9, 12 and 13. The plurality of crosspieces 31R is disposed on the sectioning member 31SP and the bottom portion 31B, more specifically, a surface of the rear bottom portion 31BR on the top portion 31T side of the battery case 31. In the same manner, the plurality of crosspieces 31R is disposed on the bottom portion 31B of the battery case 31, more specifically, a surface of the front bottom portion 31BF on the top portion 31T side of the battery case 31. In the present embodiment, the plurality of crosspieces 31R is disposed such that the extending direction thereof (longer side direction) and the horizontal direction (width direction W) of the battery case 31 become parallel.

As illustrated in FIG. 16, the respective crosspieces 31R contact lower surfaces 32B of the battery cell 32 and support the battery cell 32. The plurality of crosspieces 31R is disposed between the lower surfaces 32B of the battery cells 32, sectioning member 31SP, and rear bottom portion 31BR and between the lower surfaces 32B of the battery cells 32 and the front bottom portion 31BF respectively. Due to this, gas passages ARP where the gas passes respectively are formed between the lower surfaces 32B of the battery cells 32, sectioning member 31SP, and rear bottom portion 31BR and between the lower surfaces 32B of the battery cells 32 and the front bottom portion 31BF. Further, the gas passages ARP are also formed between the top portion 31T of the battery case 31 and the top portion 31T of the plurality of battery cells 32 and between the sectioning member 31SP and the top portion 31T of the plurality of battery cells 32 respectively.

With this structure, the gas introduced into the battery case 31 from the first intake ports 31HI and the second intake port 31HIe illustrated in FIGS. 9, 11, and 13 flows contacting an upper surfaces 32T and the lower surfaces 32B of the plurality of battery cells 32 disposed between the top portion 31T, sectioning member 31SP, and rear bottom portion 31BR, and contacting the upper surfaces 32T and the lower surfaces 32B of the plurality of battery cells 32 disposed between the sectioning member 31SP and the front bottom portion 31BF in the process of the gas passing through the gas passages ARP. Thus, the battery cells 32 are cooled. Especially, in the case of charging the battery 30 fast, the respective battery cells 32 generate heat. Therefore, the heat generated by the plurality of battery cells 32 is exhausted to the outside of the battery case 31 by flowing the gas through the gas passages ARP.

As illustrated in FIG. 16, some of the crosspieces 31R contact the lower surfaces 32B of two battery cells 32, and some of the crosspieces 31R contact the lower surface 32B of one battery cell 32. The respective crosspieces 31R extend to the exhaust ports 31HE from the first intake ports 31HI and the second intake port 31HIe. Therefore, the plurality of crosspieces 31R sections the gas passage ARP disposed between the plurality of battery cells 32, sectioning member 31SP, and rear bottom portion 31BR and the gas passage ARP disposed between the plurality of battery cells 32 and the front bottom portion 31BF into a plurality of passages. Such passages are the passages between the adjacent crosspieces 31R, 31R. With this structure, the gas introduced into the battery case 31 from the first intake ports 31HI and the second intake port 31HIe is divided by the plurality of crosspieces 31R, and flows in the respective passages. Therefore, gas distribution can be uniformed in a direction orthogonal to the extending direction of the crosspieces 31R. As a result, temperature variation among the plurality of battery cells 32 can be prevented.

In the present embodiment, a part of the battery 30, more specifically, a part of the side portion 31SB side on the rear side is disposed in the storage unit 20S of the counter weight 20 illustrated in FIGS. 1 to 7. As described above, the storage unit 20S of the counter weight 20 is covered with the cover 26, thereby causing stagnation of air flow and making an environment in which the battery 30 is hardly cooled. In the present embodiment, the battery 30 includes the second intake port 31HIe at the portion stored in the storage unit 20S of the counter weight 20. The battery cells 32 at the portion stored in the storage unit 20S of the counter weight 20 are cooled by the air that flows into the battery case 31 from the second intake port 31HIe. Further, since the battery case 31 includes the gas passages ARP as described above, the air flowing into the battery case 31 from the second intake port 31HIe effectively cools the battery cells 32. Moreover, as described above, the air in the outside is introduced into the storage unit 20S from the passage 21 included in the counter weight 20, and this air flows into the battery case 31 from the second intake port 31HIe. As a result, the battery cells 32 are effectively cooled.

In the present embodiment, the second space 72 and the third space 73 are connected to the gas passages ARP disposed on the side portion 31SB on the rear side of the battery 30. The second space 72 and the third space 73 function as an air header because both spaces have the certain level of volume. Therefore, the air flowing from the second intake port 31HIe is stored in the second space 72 having the certain level of volume, and the pressure is made uniform. Then, the air is distributed to the respective passages divided by the plurality of crosspieces 31R. Therefore, imbalance of flow rates of the air flowing in the respective passages is reduced. Further, the air flowing from the respective passages flows out to the third space 73, and then is exhausted to the outside of the battery case 31 by the fans 31F. Since the third space 73 has the certain level of volume, the pressure inside the third space 73 is uniform. Therefore, imbalance of flow rates of the air flowing in the respective passages is reduced.

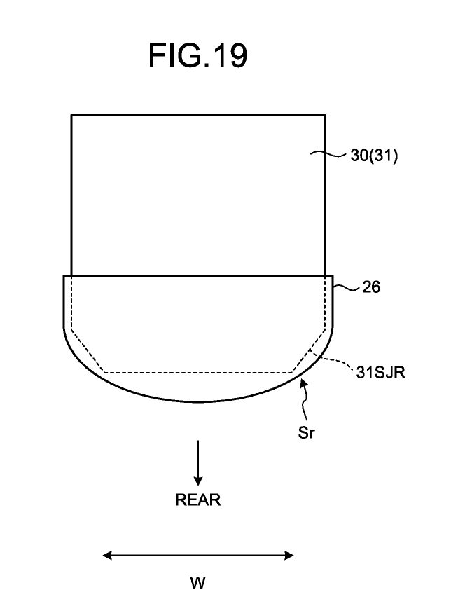

FIG. 19 is a plan view illustrating a relation between the cover 26 included in the battery-powered forklift 1 and the battery 30. FIG. 19 illustrates the cover 26 and the battery 30 in a state viewed from above. In the present embodiment, the cover 26 has the shape that is narrowed toward the rear side of the battery-powered forklift 1 when viewed from above. In other words, the cover 26 includes the portion having a width gradually reduced as a position approaches to the rear side. As described above, the battery case 31 has the shape in which the portion located on the rear side of the battery-powered forklift 1 is narrowed when viewed from above. The passage 21 illustrated in FIGS. 4 to 6 is disposed at the portion of the counter weight 20 corresponding to a narrowed portion Sr of the cover 26. The second intake port 31HIe is disposed at the narrowed portion of the battery case 31, namely, the right connecting portion 31SJR.

Thus, the shape of the portion to be stored in the storage unit 20S of the counter weight 20 and further covered with the cover 26, out of the battery 30, is formed conforming to the shape of the cover 26, thereby achieving to surely store the battery 30 inside the cover 26.

In the present embodiment, a part of the battery 30 is stored in the storage unit 20S of the counter weight 20 included in the battery-powered forklift 1, and further the passage 21 connecting the storage unit 20S to the outside is provided at the counter weight 20. With this structure, even in the case where a part of the battery 30 is stored in the portion where the cooling medium such as the air tends to stagnate, a cooling medium can be introduced into the storage unit 20S from the passage 21. As a result, in the battery-powered work vehicle, the work vehicle battery mounted at the portion where heat is hardly radiated, such as a portion surrounded by components, can be cooled.

In the present embodiment, a part of the battery 30 is stored inside the storage unit 20S of the counter weight 20 included in the battery-powered forklift 1. The battery case 31 includes the intake port 31HIe at the portion stored in the storage unit 20S. With this structure, the battery case 31 can introduce the cooling medium from the intake port 31HIe even in the case where a part of the battery 30 is stored in the portion where the cooling medium such as the air tends to stagnate. As a result, in the battery-powered work vehicle, the work vehicle battery mounted at the portion where heat is hardly radiated, such as a portion surrounded by components, can be cooled.

While the present embodiment has been described above, but note that the present embodiment is not limited to the described content. Further, the components described above may include components readily conceivable by those skilled in the art, components substantially identical, and components in a so-called equivalent range. Further, the components described above can be suitably combined. Furthermore, various kinds of omission, replacement, and modification may be made in the components in the scope without departing from the gist of the present embodiment.

### REFERENCE SIGNS LIST

1 BATTERY-POWERED FORKLIFT
10 VEHICLE BODY
10HR FIRST HOLE
10HL SECOND HOLE
13 FORK
20 COUNTER WEIGHT
20H OPENED PORTION
20HT END PORTION
201 HOLE
20L SIDE PORTION
20S STORAGE UNIT
21 PASSAGE
26 COVER
26UT LOWER END
30 BATTERY (WORK VEHICLE BATTERY)
31 BATTERY CASE
31B BOTTOM PORTION
31BF FRONT BOTTOM PORTION
31BR REAR BOTTOM PORTION
31F FAN
31HE EXHAUST PORT
31HI FIRST INTAKE PORT
31HIe SECOND INTAKE PORT (INTAKE PORT, HOLE)
31R CROSSPIECE
31SB, 31SF, 31SL, 31SR SIDE PORTION
31SBs LOWER SIDE PORTION
31SBu UPPER SIDE PORTION
31SJL LEFT CONNECTING PORTION
31SJR RIGHT CONNECTING PORTION
31SP SECTIONING MEMBER
31T TOP PORTION
32 BATTERY CELL
32B LOWER SURFACE
32T UPPER SURFACE
33 BATTERY COVER
40 MEMBER
40L LEG PORTION
40P CONNECTING PORTION
41 OPENED PORTION
42 OPENED PORTION
71 FIRST SPACE
71s LOWER FIRST SPACE
71u UPPER FIRST SPACE
72 SECOND SPACE
73 THIRD SPACE
ARP GAS PASSAGE
CAB CABLE

1. A battery-powered work vehicle, comprising:
a vehicle body on which a battery is mounted;
a counter weight disposed at one end portion of the vehicle body, and including a storage unit opened to an upper side of the vehicle body, the storage unit storing a part of the battery;
a passage disposed at a part of the counter weight and configured to connect the storage unit to an outside of the counter weight; and
a cover provided above the counter weight and configured to cover a part of an opening of the passage on outside of the counter weight.

2. The battery-powered work vehicle according to claim 1, wherein
the battery is mounted inside the vehicle body, and
the vehicle body includes, on one side portion in a width direction, a first hole connecting inside and outside of the vehicle body, and includes, on the other side portion in the width direction, a second hole connecting the inside and the outside of the vehicle body.

3. A battery-powered work vehicle, comprising:
a vehicle body on which a battery including a plurality of battery cells and a battery case to store the battery cells is mounted;
a counter weight disposed on one end portion of the vehicle body, and including a storage unit opened to an upper side of the vehicle body, the storing unit storing a part of the battery;
a passage disposed at a part of the counter weight and configured to connect the storage unit to an outside of the counter weight; and
a cover disposed above the counter weight and configured to cover at least a part of a portion opened to an upper side of the counter weight, wherein
the battery case includes a hole at a part of a portion stored in the counter weight.

4. The battery-powered work vehicle according to claim 3, wherein a position of the passage in a width direction of the battery-powered work vehicle is aligned with a position of the hole.

5. The battery-powered work vehicle according to claim 3, wherein the passage and the hole at least partly overlap in the width direction of the battery-powered work vehicle.

6. The battery-powered work vehicle according to claim 3, wherein
the cover has a shape that is narrowed toward a rear side of the battery-powered work vehicle when viewed from above,
the battery case has a shape in which a portion located on the rear side of the battery-powered work vehicle is narrowed when viewed from above, and
the passage is disposed at a portion of the counter weight corresponding to the narrowed portion of the cover, and the hole is disposed at the narrowed portion of the battery case.

7. The battery-powered work vehicle according to claim 3, wherein the battery case includes a member to cover the hole, and the member includes an opening configured to allow gas to flow into the hole.

8. The battery-powered work vehicle according to claim 3, wherein a lower end of the hole is positioned higher than an upper end of the passage.

9. The battery-powered work vehicle according to claim 3, wherein
the battery is mounted inside the vehicle body,
the vehicle body includes, on one side portion in a width direction, a first hole connecting inside and outside of the vehicle body, and includes, on the other side portion in the width direction, a second hole connecting the inside and the outside of the vehicle body, and
the hole is disposed on one side portion.

10. A work vehicle battery mounted on a battery-driven work vehicle and configured to supply power to the work vehicle, comprising:
a plurality of battery cells;
a battery case including a bottom portion, a top portion facing the bottom portion, side portions connecting the bottom portion and the top portion, and configured to store the battery cells in a first space surrounded by the top portion, the bottom portion, and the side portions;
a first intake port opened at a portion, out of the side portions, disposed in a width direction of the work vehicle when the battery is mounted on the work vehicle, and configured to introduce gas into the battery case;
a second space formed between the side portions and ones out of the battery cells;
a second intake port opened at a portion, out of the side portions, located more on a rear side of the work vehicle than the first intake port when the battery is mounted on the work vehicle, and configured to connect the second space to outside of the battery case and introduce gas into the second space;
an exhaust port opened at a side portion facing the side portion where the first intake port is opened, and configured to exhaust gas from the battery case; and
a fan configured to exhaust gas from the exhaust port after introducing the gas into the battery case from the first intake port and the second intake port and allowing the gas to flow contacting upper surfaces and lower surfaces of the battery cells.

11. The work vehicle battery according to claim 10, wherein the battery case includes a member to cover the second intake port, and the member includes an opening allowing gas to flow into the second intake port.

12. The work vehicle battery according to claim 10, wherein
the battery case includes a sectioning member configured to section the first space between the top portion and the bottom portion,
the battery cells are disposed between the top portion and the sectioning member and between the sectioning member and the bottom portion respectively, and
gas introduced into the battery case from the first intake port and the second intake port flows, contacting upper surfaces and lower surfaces of the battery cells disposed between the top portion and the sectioning member, and contacting upper surfaces and lower surfaces of the battery cells disposed between the sectioning member and the bottom portion.

13. The work vehicle battery according to claim 10, wherein the second space connects the first spaces sectioned by the sectioning member, and a cable that mutually and electrically connects the battery cells is passed between one of the sectioned first spaces and the other one of the sectioned first spaces.

14. The work vehicle battery according to claim 10, wherein
the battery case includes a third space formed between the side portions and the ones out of the battery cells, and located at a portion different from the second space, and
a part of the exhaust port is opened to the third space.

15. The work vehicle battery according to claim 14, wherein the third space mutually connects the first spaces sectioned by the sectioning member, and a cable that mutually and electrically connects the battery cells is passed between one of the sectioned first spaces and the other one of the sectioned first spaces.

16. The work vehicle battery according to claim 14, wherein the second space is disposed on a side of the side portions where the first intake port is opened, and the third space is disposed on a side of the side portions where the exhaust port is opened.

17. The work vehicle battery according to claim 10, wherein
among the side portions, a first side portion located on a rear side of the work vehicle has a size in the width direction smaller than a distance between a second side portion where the first intake port is opened and a third side portion where the exhaust port is opened when the battery is mounted on the work vehicle, and
the second intake port is opened at a portion connecting the first side portion to the second side portion.
